(19) United States
(12) Patent Application Publication
(10) Pub. No.: US 2025/0005212 A1
(43) Pub. Date: Jan. 2, 2025

(54) SYSTEMS AND METHODS FOR ARTICLE DESIGN AND PRODUCTION

(71) Applicant: NIKE, Inc., Beaverton, OR (US)

(72) Inventor: Diana Yan, Portland, OR (US)

(21) Appl. No.: 18/757,179

(22) Filed: Jun. 27, 2024

Related U.S. Application Data
(60) Provisional application No. 63/511,473, filed on Jun. 30, 2023.

(51) Int. Cl. G06F 30/12; D04B 1/24; G06F 111/16; G06F 113/12

(52) U.S. Cl. CPC G06F 30/12; D04B 1/24; D10B 2501/043; G06F 2111/16; G06F 2113/12

(57) ABSTRACT

Aspects herein are directed to systems and methods for designing and forming articles, such as articles of apparel. In some aspects, article design input data, such as a bitmap indicating a knit structure of an article, is received. A visual appearance of an article to be formed from the article design input data is predicted by modeling textile structures as springs attached to anchor locations. A shell mesh is created based on the predicted visual appearance. In some aspects, modifications to the shell mesh are received, and the article design input data is automatically modified based on the modifications to the shell mesh.

### CROSS-REFERENCE TO RELATED APPLICATIONS

This application claims priority from, U.S. Provisional Application No. 63/511,473, filed on Jun. 30, 2023, which is hereby incorporated by reference in its entirety.

### FIELD

Aspects herein relate to systems, methods, and computer-readable media storing computer-executable instructions thereon for designing and manufacturing knitted components for articles, such as articles of footwear.

### BACKGROUND

Some article production machines, including some knitting machines, operate automatically based on article formation instructions, such as bitmaps or instruction data based on bitmaps. However, configuring the article formation instructions (e.g., the bitmap) such that the article production machine produces an article with the desired structural or aesthetic characteristics may be challenging due to the lack of visual similarity between the article formation instructions and the desired article.

### BRIEF DESCRIPTION OF THE DRAWINGS

The present technology is described in detail herein with reference to the accompanying drawings, which are described below.

FIG. 1 illustrates an operating environment in accordance with aspects herein.

FIG. 2A illustrates a bitmap in accordance with aspects herein.

FIG. 2B illustrates a shell outline in accordance with aspects herein.

FIG. 3 illustrates a grid mesh in accordance with aspects herein.

FIG. 4 illustrates a process of forming a shell mesh in accordance with aspects herein.

FIG. 5 illustrates a shell mesh in accordance with aspects herein.

FIG. 6 illustrates a process of modifying a bitmap based on a modification to a shell mesh in accordance with aspects herein.

FIG. 7 illustrates an iterative design process in accordance with aspects herein.

FIGS. 8-10 illustrate example methods in accordance with aspects herein.

FIG. 11 illustrates a block diagram of an exemplary computing environment suitable for use in implementations of the present disclosure.

### DETAILED DESCRIPTION

### Overview

Some article production machines, including some knitting machines, operate automatically based on article formation instructions. Article formation instructions can include bitmaps, wherein each pixel of the bitmap represents a needle position and indicates a textile structure to be created at the needle position. Pixels are typically assigned different colors to denote the different textile structures. Thus, in order to instruct a textile production machine to produce a desired article, each pixel of the bitmap must be individually colored—in at least some cases, manually. This process is slow, tedious, and can be inaccurate. Moreover, configuring article production instructions such that the article production machine produces an article with the desired functional and aesthetic characteristics may be challenging due to the lack of visual similarity between the article formation instructions and the article. For example, a knitted upper for an article of footwear may bear little to no visual resemblance to a bitmap used to knit the upper, particularly when knitting techniques are utilized to create shaping (e.g., wedging/gorging) in the upper.

At a high level, aspects herein are directed to systems and methods of designing and producing articles, such as articles of apparel. In some aspects, article formation instructions are translated into a mesh data structure (e.g., for use in computer-aided design (CAD) software) that comprises a visual representation of an article to be formed based on the article formation instructions. Put another way, aspects herein are drawn to predicting (e.g., simulating) a shape, structure, and/or appearance of an article that would be produced by an article production machine if the article production machine was provided the article formation instructions.

Such article formation instructions are also referred to herein as “article design input data,” as such instructions may comprise information about a design of an article and may be used as inputs in article design and/or formation processes. Additionally, a mesh data structure having a shape of an article to be produced (or an approximate shape of an article to be produced) may be referred to herein as a “shell mesh.”

The article design input data (i.e., the article formation instructions is mapped to the mesh data structure so that modifications to the mesh data structure can automatically be made to the article formation instructions, and vice versa. For example, a user may change a yarn color of a knit course of the shell mesh, and article design input data may be modified in a manner that corresponds to the modifications to the mesh data structure. As such, article designs can be changed or iterated—and corresponding articles can be produced—in a visually intuitive manner and without manually altering pixels of the article formation instructions.

### Example Article Creation System

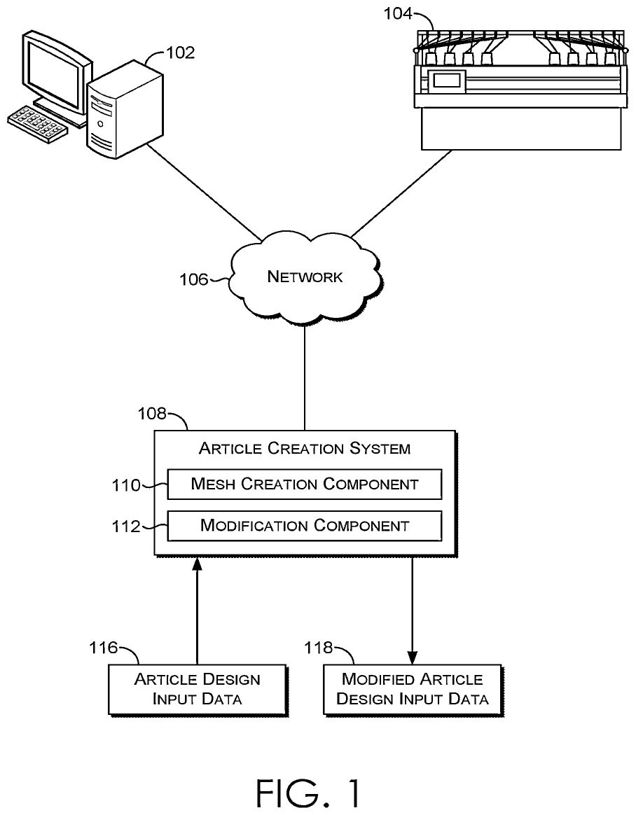

With reference now to the drawings, FIG. 1 is a block diagram illustrating an exemplary system 100 for creating articles in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

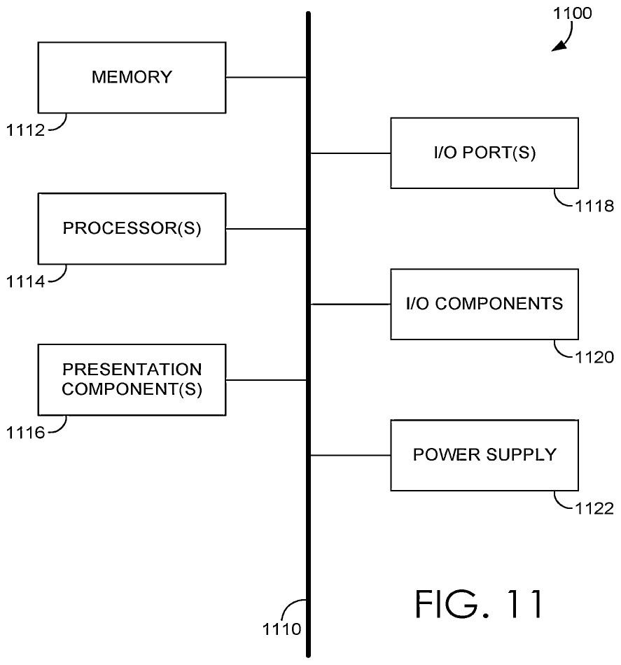

The system 100 is an example of a suitable architecture for implementing certain aspects of the present disclosure. Among other components not shown, the system 100 includes a user device 102, an article production machine 104, and an article creation system 108. Each of the user device 102, article production machine 104, and article creation system 108 shown in FIG. 1 can comprise one or more computer devices, such as the computing device 1100 of FIG. 11, discussed below. As shown in FIG. 1, the user device 102, article production machine 104, and article creation system 108 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of client devices and server devices can be employed within the system 100 within the scope of the present technology. Each can comprise a single device or multiple devices cooperating in a distributed environment. For instance, the article creation system 108 can be provided by multiple server devices collectively providing the functionality of the article creation system 108 as described herein. Additionally, other components not shown can also be included within the network environment.

The user device 102 can be a client device on the client side of operating environment 100, while the article creation system 108 can be on the server side of operating environment 100. The article creation system 108 can comprise server-side software designed to work in conjunction with client-side software on the user device 102 so as to implement any combination of the features and functionalities discussed in the present disclosure. For instance, the user device 102 can include an application for interacting with the article creation system 108. The application can be, for instance, a web browser or a dedicated application for providing functions, such as those described herein. This division of operating environment 100 is provided to illustrate one example of a suitable environment, and there is no requirement for each implementation that any combination of the user device 102 and the article creation system 108 remain as separate entities. While the operating environment 100 illustrates a configuration in a networked environment with a separate user device and material selection system, it should be understood that other configurations can be employed in which components are combined. For instance, in some configurations, a user device can also provide capabilities of the technology described herein.

The user device 102 can comprise any type of computing device capable of use by a user. For example, in one aspect, the user device can be the type of computing device 1100 described in relation to FIG. 11 herein. By way of example and not limitation, the user device 102 can be embodied as a personal computer (PC), a laptop computer, a mobile or mobile device, a smartphone, a tablet computer, a smart watch, a wearable computer, handheld communications device, gaming device or system, entertainment system, vehicle computer system, embedded system controller, appliance, consumer electronic device, workstation, or any combination of these delineated devices, or any other suitable device. A user can be associated with the user device 102 and can interact with the article creation system 108 via the user device 102.

The article production machine 104 may be an automated knitting machine or any other machine capable of producing an article, such as the articles described herein. In aspects in which the article production machine 104 is a knitting machine, the knitting machine may be a flat knitting machine, such as a flat V-bed knitting machine with a front needle bed and a back needle bed, for example. The knitting machine may form knitted components by needles from a single needle bed or by needles from both needle beds. The knitting machine may comprise and/or be coupled to one or more computing devices. As later discussed, the computing device(s) may accept computerized knitting instructions, and the knitting machine may automatically form a knitted component based on the computerized knitting instructions.

At a high level, the article creation system 108 receives article design input data 116 and models the article design input data 116 as a mesh data structure. In aspects, the article creation system 108 receives one or more modifications to the mesh data structure and makes corresponding modifications to the article design input data 116. The article creation system 108 may also (or alternatively) receive one or more modifications to the article design input data 116 and make corresponding modifications to the mesh data structure. Modified article design input data 118 may be communicated to the article production machine 104 (e.g., a knitting machine) for formation of an article (e.g., an upper for an article of footwear).

As shown in FIG. 1, the article creation system 108 includes a mesh creation component 110 and a modification component 112. The components of the article creation system 108 can be in addition to other components that provide further additional functions beyond the features described herein. The article creation system 108 can be implemented using one or more server devices, one or more platforms with corresponding application programming interfaces, cloud infrastructure, and the like. While the article creation system 108 is shown separate from the user device 102 in the configuration of FIG. 1, it should be understood that in other configurations, some or all of the functions of the article creation system 108 can be provided on the user device 102.

In one aspect, the functions performed by components of the article creation system 108 are associated with one or more applications, services, or routines. In particular, such applications, services, or routines can operate on one or more user devices or servers, be distributed across one or more user devices and servers, or be implemented in the cloud. Moreover, in some aspects, these components of the article creation system 108 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, although functionality is described herein with regards to specific components shown in example system 100, it is contemplated that in some aspects, functionality of these components can be shared or distributed across other components.

The mesh creation component 110 is configured to receive article design input data 116 (e.g., from a user) and create one or more mesh data structures based on the article design input data 116. The article design input data 116 may comprise information regarding a structure and/or design of an article. Although the illustrations discussed below primarily relate to uppers for articles of footwear, this is merely an example, and it is contemplated that the article creation system 100 may be suitable for creating any type of article. Such articles include, but are not limited to: upper-body garments, such as tops, t-shirts, pullovers, hoodies, jackets, coats, and upper-body support garments such as bras and the like; lower-body garments, such as pants, shorts, tights, and capris; hats; gloves; and sleeves.

In some aspects, the article design input data 116 comprises article formation instructions that may be executable by the article production machine 104, such as a knitting machine, or used to create executable instructions for the article production machine 104. Such instructions can comprise any suitable file type or data type, which may vary depending on the type of article production machine utilized to form the article. Some article production machines (including some knitting machines) form articles based on one or more bitmaps (e.g., .bmp files).

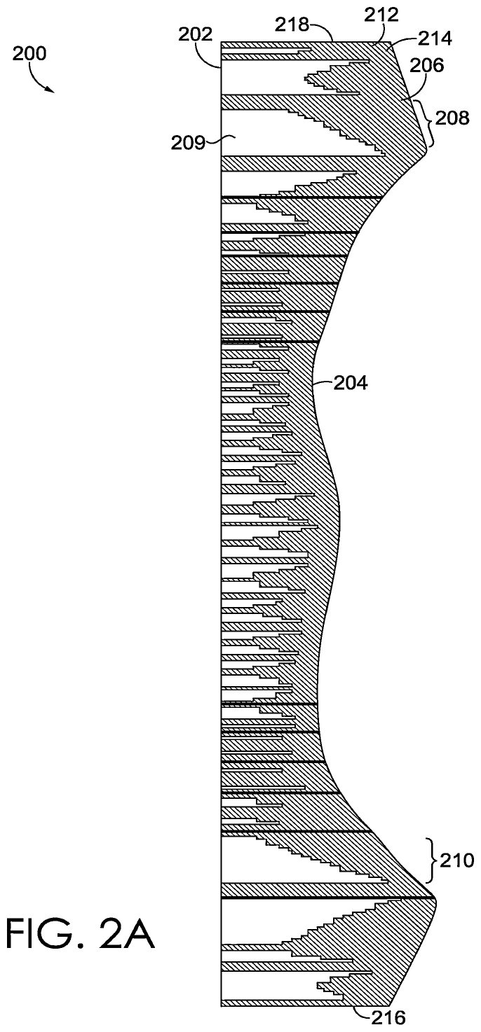

FIG. 2 illustrates an example bitmap 200 suitable for instructing a knitting machine to form an upper for an article of footwear. The bitmap 200 comprises a grid of pixels. Each shaded horizontal row of pixels represents a knit course, and each pixel within the row represents a needle position within a needle bed of a knitting machine (e.g., the article production machine 104 shown in FIG. 1). The rows of pixels collectively represent the courses making up a knit article such that each pixel of the bitmap 200 represents portion of that knit article. Pixels of the bitmap can be shaded, color-coded, or otherwise demarcated to indicate one or more properties of the article at the location corresponding to the pixel. These properties may include a yarn color, yarn type, yarn shape, or knit stitch type of the corresponding location of the article, for example.

In aspects in which the article to be formed is an upper for an article of footwear, the article formation instructions (e.g., the bitmap) can comprise instructions to create wedging in the upper. “Wedging” refers to the practice of forming at least a portion of an article using partial knit courses (e.g., knit courses that terminate at a location other than an edge of the article), which may be used to create three-dimensional structure or other types of shaping.

To illustrate, the bitmap 200 shown in FIG. 2 contains both full length knit courses (e.g., knit course 212) extending from the right edge 204 to the left edge 202, and partial length knit courses (e.g., knit course 214) that extend from the right edge 204 but terminate before the left edge 202. In this way, the partial length knit courses are knit on fewer needles than the full length knit courses. Additionally, as illustrated, the partial length knit courses may vary in length, with some partial length knit courses being longer than others. The bitmap 200 includes several “wedges,” including 208 and 210, where a group of partial length knit courses separate full length knit courses. Although the bitmap shows the wedges 208 and 210 as having empty space in areas to the left of the partial knit courses, the portions represented by pixels immediately above and below the empty space in the wedges 208 and 210 are knit together, resulting in a curved, wedge-like shape structure in the article once it is formed.

In this example, at least some of the wedging shown in the bitmap 200 represents a radial knitting technique, which causes knit courses in the produced article to each radiate from a common area. For example, the knit courses may extend from the outer perimeter of an upper (represented by right edge 204) toward a throat portion of the upper (represented by left edge 202). Additionally, the first course to be knit according to the bitmap 200 is adjacent the bottom edge 216 of the bitmap 200 and represents a heel edge on either the lateral side or the medial side of the upper. The last course to be knit is adjacent the top edge 218 of the bitmap 200 and represents a heel edge on the other side of the upper. In this way, a radially-knit upper is knit from a heel region on one side, to the toe region, and then back down to the heel region on the opposite side.

In some aspects, the article design input data 116 comprises a shell outline. The shell outline may comprise a two- or three-dimensional shape or form of an article. The shell outline may be a shape of the article to be formed according to the article formation instructions (e.g., the bitmap 200). The shell outline may be received from a user device, for example. Suitable file types for the shell outline include, but are not limited to, Adobe Illustrator® (.ai) and Portable Document Format (.pdf). In some aspects, the shell outline may be (or be derived from) a template (e.g., a default or previously-utilized shape of an article).

FIG. 2B illustrates an example shell outline 220 comprising a shape of an upper for an article of footwear. The shell outline 220 comprises a throat boundary 222 and a perimeter boundary 224. The throat boundary 222 corresponds to the left edge 202 of the bitmap 200, and the perimeter boundary 224 corresponds to the right edge 204 of the bitmap 200.

In order to facilitate creation of a shell mesh, for example, the mesh creation component 110 may convert the article formation instructions (e.g., the bitmap) to a grid mesh, which can comprise a mesh data structure (e.g., a mesh file format). At a high level, a mesh data structure is a two- or three-dimensional model comprising units (or “faces”) formed between edges (e.g., lines). Examples of mesh file formats include, but are not limited to, stereo lithography (.stl), standard for the exchange of product (.stp or .step), object (.obj), and DirectX (.x) files.

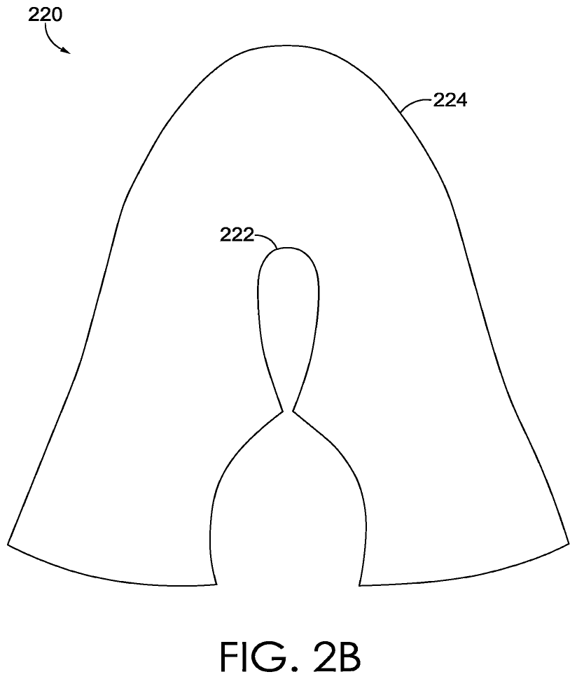

In some aspects, the grid mesh is a “quad mesh”—i.e., a mesh that comprises “quads,” or four-sided shapes formed by edges. The grid mesh may represent a plurality of knit structures in an arrangement. For example, each quad of the grid mesh may represent a textile structure, such as a knit stitch (e.g., knitted loop stitch or a float stitch). A horizontal row of quads within the grid mesh (when viewed as shown in FIG. 3) represents a course. FIG. 3 illustrates such a grid mesh 300. The grid mesh 300 is a quad mesh derived from the bitmap 200 shown in FIG. 2A. Each quad of the grid mesh 300 represents a knit stitch of an upper to be formed based on the article formation instructions—in this case, the bitmap 200.

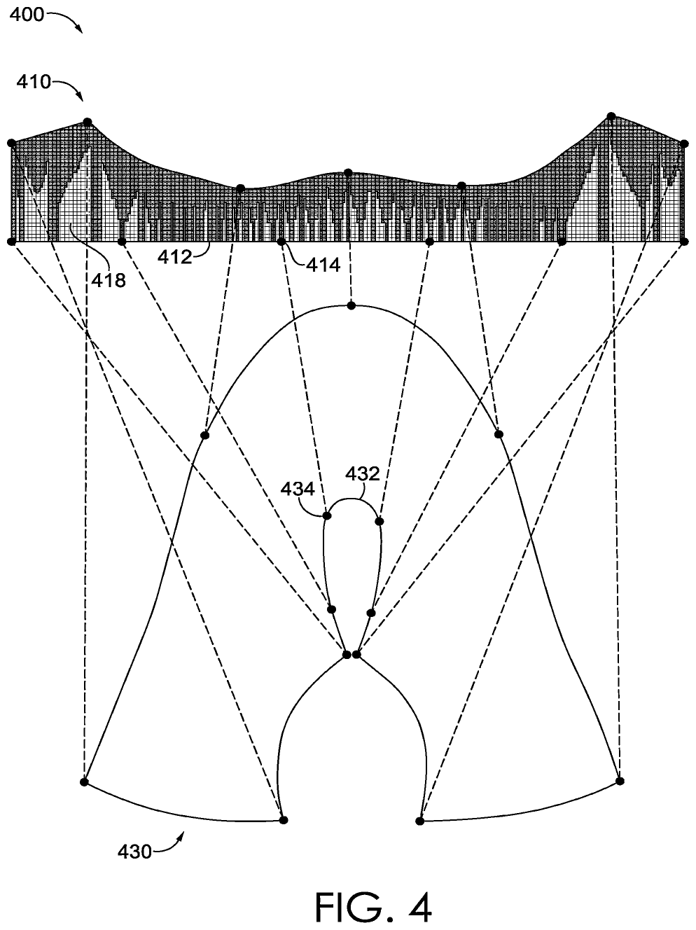

The mesh creation component 110 is further configured to map a grid mesh (e.g., the grid mesh 300) onto a shell mesh. As used herein, the term “shell mesh” refers to a mesh data structure having a shape of an article to be produced (or an approximate shape of an article to be produced). In aspects of the present disclosure, the shell mesh may, for example, have a shape corresponding (e.g., equivalent) to a shape of the shell outline received by the shell creation component 110. For instance, in the example shown in FIG. 5, which is discussed below, the shape of the shell mesh 500 corresponds to the shape of the shell outline 220 of FIG. 2B.

Similar to the grid mesh (e.g., grid mesh 300), the shell mesh (e.g., shell mesh 500) comprises “quads” each representing a textile structure. The grid mesh and shell mesh are each mesh data structures representing the same textile structures but in different arrangements. The shell mesh includes quads representing the textile structures in a first arrangement, which represents the arrangement that will be present in the produced article, while the grid mesh includes quads representing the textile structures in a second arrangement, which is the arrangement of corresponding pixels in the bitmap. While the second arrangement reflected in the bitmap is used for actual production of the article, the first arrangement corresponds to how a produced article will look and, therefore, is easier to use when creating and/or modifying a design intended for the produced article.

Mapping the grid mesh to the shell mesh may be to provide a prediction regarding a visual appearance of an article to be formed based on the article formation instructions (e.g., bitmap). Further, the mapping of the grid mesh to the shell mesh results in synchronization between the grid mesh and the shell mesh such that modifications the shell mesh may automatically effectuate or trigger corresponding modifications to the grid mesh, and vice versa. Automatically modifying a mesh data structure with textile structures in one arrangement conducive to design to reflect modifications of another mesh data structure with the textile structures in another arrangement conducive to article production increases the efficiency and accuracy of the design and manufacturing process.

In order to create an accurate synchronization of the two mesh structures, the mesh creation component 110 may (a) map anchor points of the grid mesh to anchor locations of the shell outline and/or (b) assign spring lengths to edges of the grid mesh. Put another way, the mesh creation component 110 may determine (or receive information regarding) locations of the shell mesh that necessarily correspond to locations of the grid mesh. The mesh creation component 110 may map these locations (e.g., points) from the grid mesh to the shell mesh. The mesh creation component 110 may model the edges of quads (e.g., corresponding to textile structures) of the grid mesh as springs and map the remaining (e.g., non-anchor) portions of the grid mesh to the shell mesh based on a physics-based simulation of the interactions between the springs.

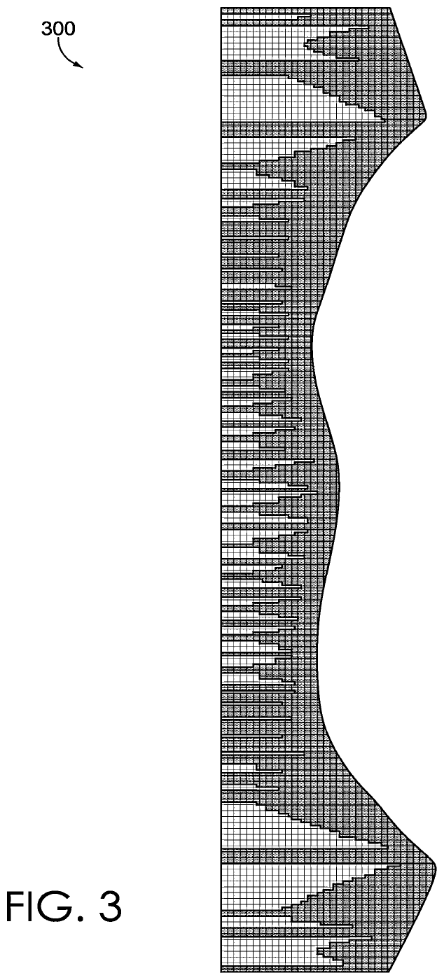

FIG. 4 illustrates an example process 400 of mapping locations of a grid mesh 410 to locations of a shell mesh 430. The grid mesh 410 may correspond to the grid mesh 300 of FIG. 3, and the shape of the shell mesh 430 may correspond to the shape of the shell outline 220 of FIG. 2B. In the example shown in FIG. 4, the shell mesh 430 is shaped like an upper for an article of footwear. (This is merely an example, and as previously discussed, it is contemplated that the article creation system 100 is suitable for the creation of other types of articles as well.) The mesh creation component 110 may determine that anchor points on the grid mesh 410 correspond to anchor locations of the shell mesh 430. In the example shown in FIG. 4, the mesh creation component 110 determines that anchor points (e.g., 414) on the edge 412 correspond to anchor locations on the throat boundary 432 of the shell mesh 430. In some aspects, this determination based on user input (e.g., received by the mesh creation component 110 from the user device 102), such as a manual mapping of anchor points of the grid mesh 410 to respective anchor locations of the shell mesh 430.

Alternatively, or in addition, the determination can be based on information regarding a method to be used to form (e.g., knit) the article. For example, the mesh creation component 110 can select locations from which knit courses extend (e.g., at which knit courses begin) as anchor points of the grid mesh and/or anchor locations on the shell mesh.

The anchor points in the grid mesh and/or the anchor locations in the shell mesh may be vertices—e.g., intersections of edges. Moreover, in some aspects, the mesh creation component 110 utilizes each vertex on a perimeter of the grid mesh as an anchor point, but may exclude vertices that are located within (and/or adjacent to) wedges.

The mesh creation component 110 may also assign spring lengths to edges of the grid mesh 410. That is, the mesh creation component 110 can model the interactions between the (virtual) textile structures (e.g., knitted stitches) as interactions between simulated springs that exert force on one another. In some aspects, the mesh creation component 110 assigns a same spring length to each edge of the grid mesh 410. In other aspects, the spring lengths assigned to edges may vary based on one or more of a yarn type, a yarn thickness, a knit stitch type, and a knit density (which may be based on the gauge of the needle beds and/or knitting tension) associated with the edge.

In aspects, the grid mesh 410 includes mesh units correspond to a location at which no textile structure is to be formed (e.g., empty space or a gap adjacent the wedges). The edges of these mesh units corresponding to the wale-wise direction may be assigned spring lengths of zero by the mesh creation component 110. For example, the area 418 of the grid mesh 410 corresponds to the area 209, where shaded areas of the bitmap 200 separated by empty space on the bitmap 200 are joined through knitting as previously discussed with respect to FIG. 2A. As explained, no knit courses will be formed in the portion of the article corresponding to the area 209, so each wale-wise edge within the area 418 may be assigned a spring length of zero. The orientation of the example grid mesh 410 is such that these wale-wise edges assigned a spring length of zero are horizontal edges, but it will be appreciated that where the grid mesh is rotated 90 degrees (e.g., as shown in FIG. 3), such wale-wise edges extend vertically.

In some aspects, various spring length and anchor point/location assignments are considered constraints or features in creating the shell mesh 430. Such features of may be assigned strength levels or priorities. Assigning priorities to features may cause the CAD software and/or physics solver to accurately resolve conflicting instructions or forces. For example, edges with spring lengths of zero may have a highest priority, anchor points and/or locations may have a lower priority than the edges with spring lengths of zero, and/or edges having nonzero spring lengths may have a lower priority than the anchor points and/or locations. In this example, because the edges of spring length zero (e.g., the locations at which no knit stitches are formed) have the highest priority, the CAD software and/or physics solver will prioritize ensuring that these edges maintain their length of zero-even if doing so requires at least some of the edges with nonzero spring lengths to have spring lengths that vary from the actual spring length set for such edges.

Turning now to FIG. 5, the shell mesh 500 represents the shell mesh 430 of FIG. 4 following completion of the mapping process. The shell creation component 110 may create the completed shell mesh 500 by simulating interactions between the edges (which may be represented by springs) relative to the anchor points. The shell creation component 110 can carry out this process using any suitable software, such as computer-aided design (CAD) software and/or a physics solver. One non-limiting example of a computer program suitable for carrying out aspects of the present disclosure is Rhinoceros® (also known as Rhino3D®). One non-limiting example of a physics solver suitable for carrying out aspects of the present disclosure is Kangaroo Physics, which is a plugin compatible with Rhinoceros®.

The completed shell mesh may comprise units having the same number of sides as the grid mesh from which the shell mesh was formed. For example, the shell mesh 500 was generated (at least in part) from the grid mesh 410, which is a quad mesh (as previously discussed). Thus, the shell mesh 500 is also a quad mesh.

The shell mesh may also comprise features that do not represent knit stitches. For example, the shell mesh 500 is depicted in FIG. 5 as having tensile elements (e.g., 502), which may be inlaid strands or cables. However, this is merely an example, and it is contemplated that shell meshes generated in accordance with aspects herein may or may not comprise elements or features in addition to knit stitches.

The modification component 112 (shown in FIG. 1) may receive one or more modifications to a shell mesh. For example, in some cases, a user may wish to make visual and/or structural changes to a shell mesh. Thus, in some aspects, the shell mesh (e.g., the shell mesh 500) is presented for display at a user device (e.g., the user device 102), and the one or more modifications are received from the user device. Further, the modification(s) may be received from a user interface design component—e.g., CAD and/or textile design software.

The modification may be a modification of at least one textile structure (e.g., a knit structure), which may be represented by a quad of the shell mesh (as previously discussed). The modification may be an assignment of and/or modification to any of the following, for example: a textile type, a yarn type, a textile shape, a yarn shape, a yarn thickness, a textile color, a yarn color, and a knit stitch type.

The modification component 112 may automatically modify article design input data, such as article formation instructions (e.g., the bitmap 200), based on the modification(s) to the shell mesh. For example, the modification component 112 may access the grid mesh that corresponds to the shell mesh (e.g., from which the shell mesh was formed) and modify edges and/or units (as applicable) of the grid mesh in accordance with the manner in which the shell mesh was modified. Additionally, or alternatively, the modification component 112 may access the article formation instructions (e.g., bitmap) based on which the shell mesh was formed and modify the article formation instructions (e.g., modify pixels of the bitmap) based on the modifications to the shell mesh. For example, if the modification to the shell mesh comprises an assignment of a color to a quad of the shell mesh, the modification component 112 may identify a pixel of the bitmap that corresponds to the edge of the shell mesh and modify (e.g., change the color of) the pixel accordingly.

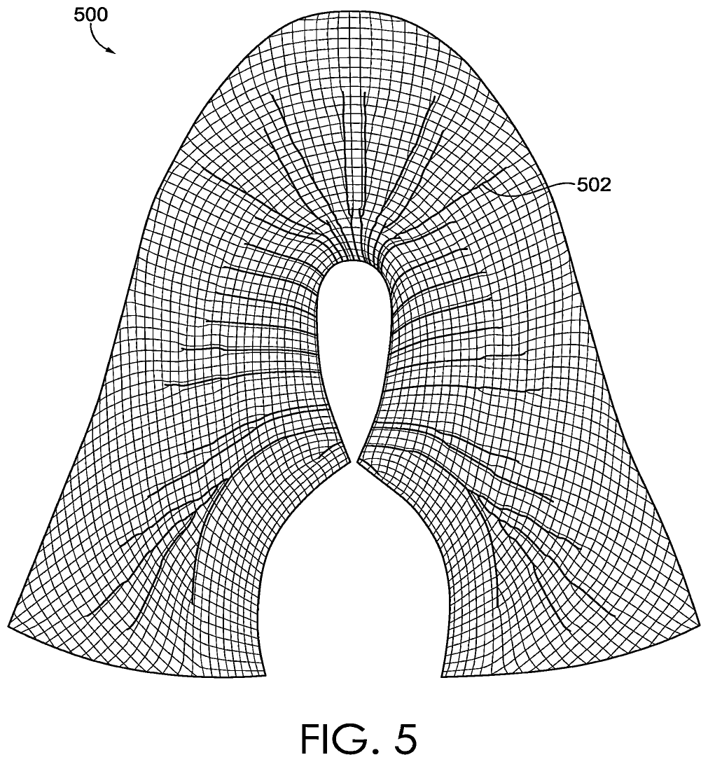

FIG. 6 illustrates a process 600 of modifying a bitmap 620 based on a modification 612 to a shell mesh 610. The shell mesh 610 (excluding the modification 612 thereto) may correspond to the shell mesh 500 of FIG. 5. The example modification 612 is an alteration to the color (or pattern) of a plurality of edges and/or units (e.g., faces) of the shell mesh 610. As shown in FIG. 6, the modification component 112 identifies pixels 622 of the bitmap 620 (which may correspond to the bitmap 200) that correspond to the modified portion 612 of the shell mesh 610. The modification component 112 modifies (e.g., assigns or changes) a color or value of the modified pixels 622 of the bitmap 620—e.g., such that the modification 612 to the shell mesh 610 will be reflected in an article formed based on the bitmap 620. The modified bitmap 620 corresponds to the modified article design input data 118 shown in FIG. 1.

In some aspects, the modification component 112 transmits the modified article design input data 118 (e.g., a modified bitmap, such as the modified bitmap 620) to an article production (e.g., knitting) machine, such as the article production machine 104 shown in FIG. 1. The transmission of the modified article design input data 118 may cause the article production machine 104 to generate computerized textile production instructions—e.g., computerized knitting instructions. The article production machine 104 may form (e.g., knit) an article based on the computerized knitting instructions.

In some aspects, instead of (or in addition to) modifying article design input data 116 (e.g., a bitmap) based on a change to a shell mesh, the modification component 112 receives a modification to the article design input data 116 (e.g., the bitmap) and automatically modifies the shell mesh accordingly. For example, the modification component 112 may access the grid mesh that corresponds to the bitmap (e.g., the grid mesh formed from the bitmap) and modify edges and/or units (as applicable) of the grid mesh in accordance with the manner in which the bitmap was modified. Additionally, or alternatively, the modification component 112 may access the shell mesh formed based on the bitmap and modify the shell mesh (e.g., modify edges and/or units of the shell mesh) based on the modifications to the bitmap. For example, if the modification to the bitmap comprises an assignment of a color to a pixel of the bitmap, the modification component 112 may identify an edge and/or unit of the shell mesh that corresponds to the pixel of the bitmap and modify (e.g., color) the edge and/or unit accordingly.

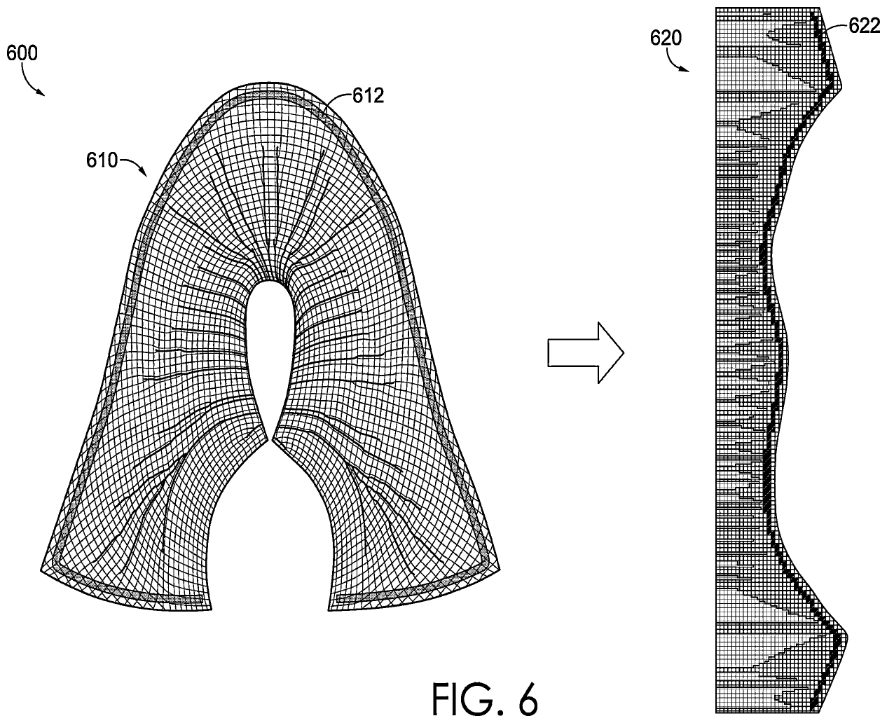

Turning now to FIG. 7, an illustration of an example process 700 for iteratively designing and/or producing articles is provided. As discussed herein, a bitmap 710 (or other type of article formation instruction) may be received. In accordance with aspects herein, a shell mesh may be generated based on the bitmap 710 as previously described. Particularly, a grid mesh generated from the bitmap 710, which may be similar the grid mesh 300, may be mapped to a shell mesh 715, which may be similar to the shell mesh 500. This mapping process may be similar to the process described with respect to FIG. 4. For brevity, a grid mesh is not shown in FIG. 7, but it should be understood that such a grid mesh would comprise quads with the same arrangement of pixels in the bitmap 710. The illustrated bitmap 710 indicates only the general shape of the article to be produced and does not include a visual design. As such, the resulting shell mesh 715 does not include a visual design besides the shape of the upper.

The shell mesh 715 generated from the bitmap 710 may be modified (e.g., visually modified at a user interface design component) to include a visual pattern, resulting in a first modified shell mesh 720. The visual pattern on the first modified shell mesh 720 marks various regions or areas. In some aspects, the visual pattern on the first modified shell mesh 720 represents an aesthetic design such that the separate areas within the visual pattern may represent different colors of yarns. In other examples, the visual pattern on the first modified shell mesh 720 represents functional zones, where each area is a zone having designated functional properties, which may be achieved in the resulting upper through specific yarns and/or sequences of knit stitches. For example, one or more zones in a toe region of the first modified shell mesh 720 may have increased breathability relative to other zones. Further, the visual pattern on the first modified shell mesh 720 may represent a combination of aesthetic design and functional zonal properties.

In some cases, a user may wish to form an article based on the first modified shell mesh 720—e.g., to determine whether a tangible article based on the modified shell mesh 720 possesses the desired aesthetic and/or functional properties. In such cases, for example, the bitmap 710 may be modified based on the modifications to the modified shell mesh 720, resulting in a first modified bitmap 730. The first modified bitmap 730 may be transmitted to an article production (e.g., knitting) machine, which may form a first article 740 based on the first modified bitmap 730. The modifications made to the shell mesh 715 (as shown in the first modified shell mesh 720) may automatically trigger corresponding modifications to the bitmap 710 (as shown in the first modified bitmap 730) due to the mapping between the original bitmap 710 and shell mesh 715.

In some cases, the user may wish to make additional modifications to the article—e.g., if the aesthetic and/or functional effects were not present as desired in the first article 740 or if the desired aesthetic and/or functional effects have changed. Thus, in some aspects, the first modified shell mesh 720 is presented for display (e.g., at a user interface design component as discussed above). Additional modifications to the first modified shell mesh 720 may be received, via a user interface design component, resulting in a second modified shell mesh 750. Such modifications may include changing the number, shape, and/or location of one or more zones in the first modified shell mesh 720 as illustrated in the example in FIG. 7. Creation of the second modified shell mesh 750 may automatically generate changes to the first modified bitmap 740, thereby creating a second modified bitmap 760 corresponding to the second modified shell mesh 750. The second modified bitmap 760 may be transmitted to an article production (e.g., knitting) machine, which may form a second article 770 based on the second modified bitmap 760.

In this manner, articles may be iteratively designed, modified, and produced efficiently. Because aspects of the present disclosure map bitmap pixels to shell mesh locations (for example), many aspects of this iterative design process—e.g., shell mesh creation, bitmap modification, and/or article production—may be performed automatically (e.g., without user input).

### Example Methods

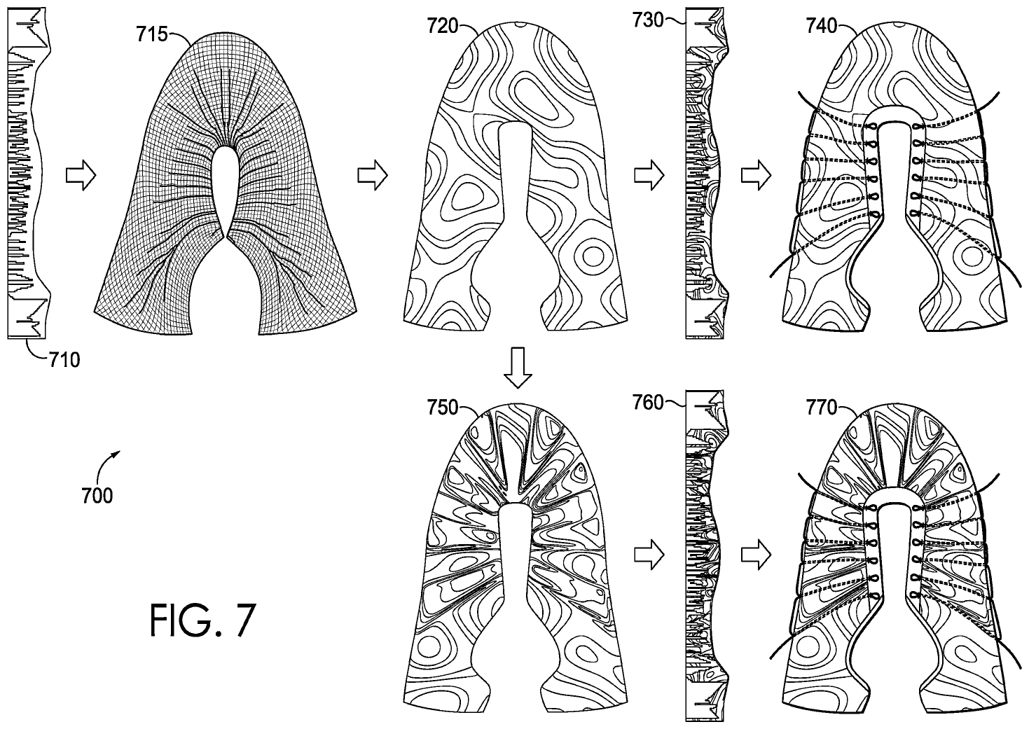

With reference now to FIG. 8, a flow diagram is provided that illustrates a method 800 for creating a shell mesh. Any of the methods of FIGS. 8-10 can be performed, for instance, by the article creation system 108 of FIG. 1. Each block of the method 800 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plugin to another product, to name a few examples.

At block 802, article design input data is received. Aspects of the article design input data are discussed with respect to article design input data 116 of FIG. 1. In example aspects, the article design input data is a bitmap that may provide article production instructions, either directly or indirectly, to an article production machine (e.g., article production machine 104). In other aspects, the article design input data received at block 802 is another data type providing article production instructions that can be interpreted by an article production machine, such as a knitting machine. The article design input data may also comprise a shell outline indicating a desired shape of an article to be formed based on the bitmap. The article design input data may represent a plurality of textile structures (e.g., knit structures) in an arrangement. For example, a bitmap may comprise a plurality of pixels, each pixel representing a needle position within a needle bed of a knitting machine and being colored or otherwise categorized or demarcated to indicate one or more properties of corresponding textile structures created at that needle position. Such properties may include a yarn color, yarn type, yarn shape, or knit stitch type. One or more portions of the article design input data may correspond to wedging in a knitted component.

At block 804, a first mesh data structure is created based on the article design input data. The first mesh data structure created at block 804 may be a grid mesh comprising units (e.g., faces) defined by and separated from each other by edges. Examples of the first mesh data structure created at block 804 include the grid meshes 300 and 410. In some aspects, the grid mesh is a quad mesh such that the units forming the grid mesh have four sides. The first mesh data structure may represent the plurality of textile structures in the same arrangement represented by the article design input data. For example, each unit (e.g., quad) of the grid mesh may represent a textile structure (e.g., a portion of a knit course, such as a knitted loop that is formed on a needle) that is also represented by a pixel of the bitmap.

At block 806, a second mesh data structure is created, where the second mesh data structure is mapped to the first mesh data structure. The second mesh data structure may be a shell mesh having units, such as quads, each representing a textile structure. Examples of the second mesh data structure include the shell meshes 500, 610, and 715. The second mesh data structure represents the same plurality of textile structures as the first mesh data structure and the article design input data but in a different arrangement. Particularly, the second mesh data structure may have a general shell outline corresponding to the intended shape or outline of the article to be formed, such as an upper.

Creating the second mesh data structure at block 806 may include determining anchor points and spring lengths. Anchor points on the first mesh data structure (e.g., grid mesh) may be determined automatically—e.g., by automatically selecting points on the first mesh data structure that are located on a perimeter of the first mesh data structure and/or correspond to points on a perimeter of the article design input data. Alternatively, or in addition, the anchor points may be determined (and/or modified) based on input from a user device (e.g., from a user). Further, edges of the first mesh data structure may be assigned spring lengths. In some aspects, each edge of the unit in the first mesh data structure is assigned a same spring length; in other aspects, edges are assigned two or more different spring lengths based, for example, on corresponding yarn types, yarn thicknesses, and/or stitch types.

In some aspects, the article input data includes pixels that are intended to represent a lack of textile structure to create wedging in the resulting article as previously described. Consequently, the first mesh data structure also includes units corresponding to locations at which there is a lack of textile structures to create wedging. Edges within the first mesh data structure that correspond to wedges (e.g., vertical edges or edges corresponding to a wale-wise direction) may be assigned spring lengths of zero. Assigning various spring lengths and anchor points to the first mesh data structure may be considered a constraint in creating the second mesh data structure. Aspects of block 806 may include further assigning a strength level or priority to the features constraining creation of the second mesh data structure, such as zero spring lengths for certain edges, nonzero spring lengths of other edges, and anchor points/locations.

Based on the first mesh data structure and shell outline—and the corresponding anchor points and anchor locations—a computer program, such as a physics solver, may simulate interactions between textile structures (e.g., edges) to map locations of the grid mesh to the shell outline, resulting in a shell mesh.

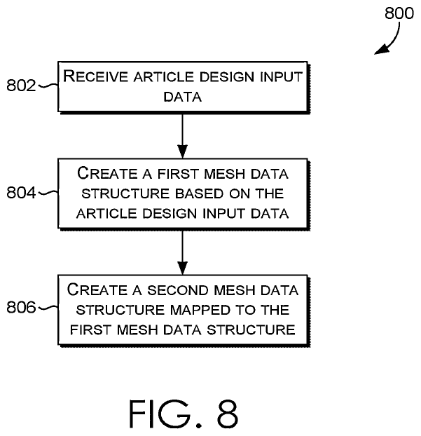

With reference now to FIG. 9, a flow diagram is provided that illustrates a method 900 for modifying article design input data.

At block 902, article design input data is received, which may be similar to block 802 described above with respect to FIG. 8. At block 904, a mesh data structure is created based on the article design input data. This mesh data structure may be a shell mesh and may be created as described in accordance with examples of blocks 804 and 806 of FIG. 8. As such, portions of the mesh data structure (e.g., mesh units) may be mapped to portions of another arrangement of mesh units that correspond to the article design input data.

At block 906, a modification to the mesh data structure is received. The modification may be a modification of at least one textile structure (e.g., a knit structure), which may be represented by a unit, such as a quad, of the shell mesh. The modification may be an initial assignment of and/or modification to any of the following, for example: a textile type, a yarn type, a textile shape, a yarn size, a yarn shape, a textile color, a yarn color, and a knit stitch type. The modification may be to an individual textile structure (representing by an individual unit of the mesh data structure). For example, a modification may be to change a particular unit within the mesh data structure from a first color to a second color.

In other instances, the modification received at block 906 is a modification to a zone or grouping of adjacent units representing adjacent textile structures. For example, the mesh data structure may mark a group of units as representing a breathability zone, where that zone represents a particular sequence of knit stitches (e.g., a specified quantity of knit loops followed by a one-needle transfer to create an aperture). The modification received at block 906 may comprise moving the location of the zone within the mesh data structure such that a group of units may be impacted by a single modification.

The modification of block 906 may be received by a user via a user interface design component. This user interface design component may be part of a program for creating a design of an article prior to commercial release. In other instances, the user interface design component is on a user device belonging to a consumer or being used by a consumer in a retail environment. As such, the user interface design component may be embodied in a customer-facing interface, such as a web browser. The user (e.g., consumer) may provide any of the aforementioned modifications to the shell mesh. The modifications may be transmitted over a network to a server. In this way, the modification received at block 906 may be a consumer customization of an article.

At block 908, the article design input data is automatically modified based on the modification to the mesh data structure. For example, pixels of the bitmap may be modified (e.g., assigned a new or different color or label) based on the modifications to corresponding portions (e.g., units) of the shell mesh. In some aspects, the article design input data is saved on a server in communication with the user interface design component through which the modification is received. Examples of this process are discussed further with respect to FIGS. 6 and 7.

Further aspects of method 900 include transmitting the modified article design input data to an article production machine (e.g., a knitting machine). Method 900 may further include causing an article to be formed (e.g., knitted) based on the modified article design input data, where the resulting article includes the textile structures having properties indicated by the mesh data structure.

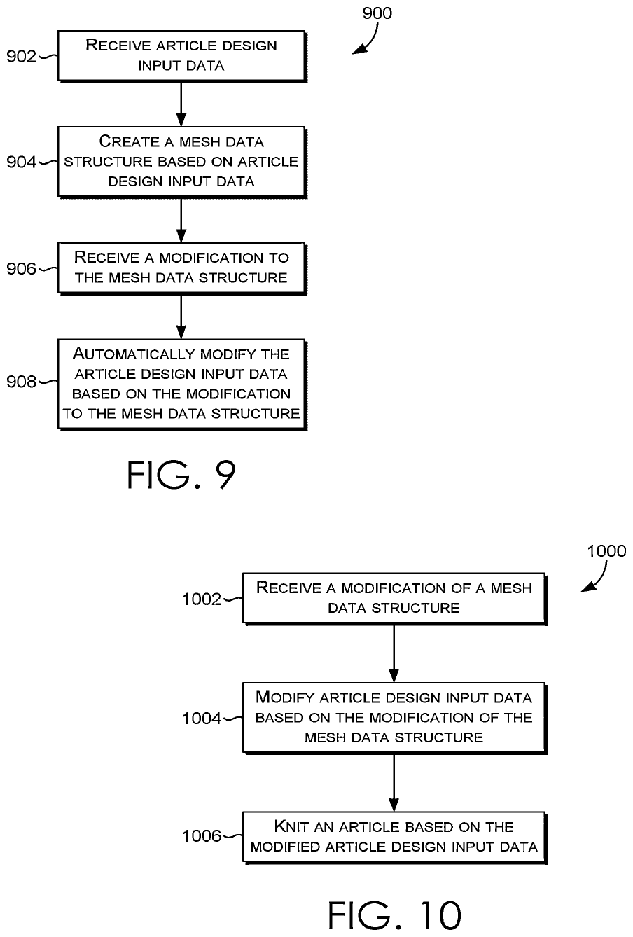

With reference now to FIG. 10, a flow diagram is provided that illustrates a method 1000 for knitting an article.

At block 1002, a modification of a mesh data structure is received. Block 1002 may be performed in accordance with aspects of block 906 described with respect to FIG. 9. As such, the modification may be a modification of a knit structure, which may be represented by a unit of the mesh data structure (e.g., a shell mesh). The modification may be an assignment of and/or modification to any of the following, for example: a yarn type, a yarn shape, a yarn size, a yarn color, and a knit stitch type. The modification may be received at a user interface design component.

At block 1004, article design input data, which may be in the format of a bitmap, is modified based on the modification of the mesh data structure. The mesh data structure may be stored on the server, for example. Portions of the mesh data structure corresponding to texture structures (e.g., pixels of a bitmap) may be modified (e.g., assigned a new or different color or label) based on the modifications to corresponding portions of the mesh data structure.

At block 1006, an article is knitted based on the modified article design input data. In some aspects, the article is knitted by an automated knitting machine, which may knit the article at least partially in response to transmission of the modified article design input data to the knitting machine. The article may be an upper for an article of footwear. In some examples, the article is an upper knitted using radial knitting methods as described herein and having wedging. When the article is an upper, the upper knit according to the modified article design input data may be attached to a sole or otherwise incorporated into an article of footwear.

### Exemplary Operating Environment

Having described implementations of the present disclosure, an exemplary operating environment in which aspects of the present technology can be implemented is described below in order to provide a general context for various aspects of the present disclosure. Referring to FIG. 11, an exemplary operating environment for implementing aspects of the present technology is shown and designated generally as computing device 1100. Computing device 1100 is but one example of a suitable computing environment and is not intended to suggest any limitation as to the scope of use or functionality of the technology. Neither should the computing device 1100 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 11, computing device 1100 includes bus 1110 that directly or indirectly couples the following devices: memory 1112, one or more processors 1114, one or more presentation components 1116, input/output (I/O) ports 1118, input/output components 1120, and illustrative power supply 1122. Bus 1110 represents what can be one or more busses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 11 is merely illustrative of an exemplary computing device that can be used in connection with one or more aspects of the present technology. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1112 includes computer storage media in the form of volatile and/or nonvolatile memory. The memory can be removable, non-removable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which can be built in. Illustrative components include a microphone, joystick, game pad, satellite dish, scanner, printer, wireless device, etc. The I/O components 1120 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1100. The computing device 1100 can be equipped with depth cameras, such as, stereoscopic camera systems, infrared camera systems, RGB camera systems, and combinations of these for gesture detection and recognition. Additionally, the computing device 1100 can be equipped with accelerometers or gyroscopes that enable detection of motion.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1: A computerized method for creating an article, the method comprising: receiving article design input data; generating a first mesh data structure based on the article design input data, wherein the first mesh data structure represents a plurality of knit structures in a first arrangement; receiving a modification of at least one knit structure of the plurality of knit structures, wherein the modification is received via a user interface design component that represents the plurality of knit structures in the first arrangement; and automatically modifying the article design input data based on the modification of the at least one knit structure.

Clause 2: The computerized method of clause 1, wherein the article design input data is a first bitmap and the modified article design input data is a second bitmap.

Clause 3: The computerized method of clause 2, wherein each pixel within the first bitmap and each pixel within the second bitmap represents one needle position within a needle bed of a knitting machine.

Clause 4: The computerized method of any of clauses 2-3, wherein the generating the first mesh data structure comprises: converting the first bitmap to a second mesh data structure; and mapping a plurality of units of the second mesh data structure to locations of the first mesh data structure.

Clause 5: The computerized method of clause 4, wherein the generating the first mesh data structure further comprises: mapping anchor points within the second mesh data structure to corresponding anchor locations of the first mesh data structure; and assigning spring lengths to edges of the second mesh data structure, wherein the mapping the plurality of units of the second mesh data structure to the locations of the first mesh data structure is based on (a) the mapping the anchor points to the anchor locations and (b) the spring lengths.

Clause 6: The computerized method of clause 5, wherein the anchor locations correspond to a throat region of an upper component for an article of footwear.

Clause 7: The computerized method of any of clauses 1-6, wherein the first arrangement of knit structures in the first mesh data structure has a shape corresponding to an upper component for an article of footwear.

Clause 8: The computerized method of any of clauses 1-7 further comprising transmitting the modified article design input data to a knitting machine.

Clause 9: The computerized method of clause 8 further comprising generating computerized knitting instructions from the modified article design input data, wherein the computerized knitting instructions cause the knitting machine to knit the article.

Clause 10: The computerized method of any of clauses 1-9, wherein the article is an upper component for an article of footwear.

Clause 11: The computerized method of any of clauses 1-10, wherein the article design input data comprises a plurality of pixels, and wherein the first mesh data structure comprises a plurality of units, each unit within the plurality of units being mapped to a pixel within the plurality of pixels.

Clause 12: The computerized method of clause 11, wherein each unit of the plurality of units comprises four edges.

Clause 13: The computerized method of any of clauses 1-12, wherein one or more edges of the first mesh data structure are assigned a spring length of zero to create wedging in the first mesh data structure.

Clause 14: The computerized method of any of clauses 1-13, wherein the modification includes an assignment of a yarn color to the at least one knit structure.

Clause 15: The computerized method of any of clauses 1-14, wherein the modification includes a change to at least one of (a) a shape of the at least one knit structure and (b) a location of the at least one knit structure.

Clause 16: The computerized method of any of clauses 1-15, wherein the creating the first mesh data structure comprises creating a mapping between (a) locations within the article design input data and (b) locations within the first mesh data structure, and wherein the automatically modifying the article design input data is further based on the mapping.

Clause 17: The computerized method of clause 16 further comprising: receiving a modification of the article design input data; and automatically modifying the first mesh data structure based on (a) the mapping and (b) the modification of the article design input data.

Clause 18: A textile production system comprising: one or more non-transitory computer readable media storing computer-executable instructions that, when executed, cause one or more computing devices to: receive article design input data; generate a first mesh data structure based on the article design input data, wherein the first mesh data structure represents a plurality of textile structures in a first arrangement; receive a modification of at least one textile structure within the plurality of textile structures, wherein the modification is received via a user interface design component that represents the plurality of textile structures in the first arrangement, and generate textile production instructions based on the modification of the at least one textile structure; and a textile production machine configured to: receive the textile production instructions; and form an article based on the textile production instructions.

Clause 19: The textile production system of clause 18, wherein the article design input data represents the plurality of textile structures in a second arrangement, and wherein the first mesh data structure is generated at least partially based on the second arrangement.

Clause 20: The textile production system of any of clauses 18-19, wherein the instructions further cause the one or more computing devices to: convert the article design input data to a second mesh data structure, assign spring lengths to edges of units of the second mesh data structure, and generate the first mesh data structure based on the spring lengths.

Clause 21: The textile production system of any of clauses 18-20, wherein the modification includes at least one of: an assignment of a yarn color to the at least one textile structure, an assignment of a knit stitch type to the at least one textile structure, a change to the yarn color of the at least one textile structure, and a change to the knit stitch type of the at least one textile structure.

Clause 22: One or more non-transitory computer-readable media storing computer-executable instructions for designing an article, wherein the instructions, when executed, cause one or more computing devices to: receive a selection of an article design; provide a user interface design component for display, wherein the user interface design component visually represents knit structures of the article design; receive a user-selected modification of the article design, wherein the user-selected modification is at least one of an assignment of a yarn color, an assignment of a knit stitch type, a change to the yarn color, and a change to the knit stitch type; and automatically generate computerized knitting instructions based on the article design and the user-selected modification, wherein the computerized knitting instructions are configured to control operation of a knitting machine such that the knitting machine knits the article.

Clause 23: The one or more non-transitory computer-readable media of clause 22, wherein the article comprises a knitted upper component for an article of footwear.

Clause 24: The one or more non-transitory computer-readable media of any of clauses 22-23, wherein the knit structures of the article design are represented as a mesh data structure comprising a plurality of edges, and wherein the user-selected modification alters at least one of (a) a color of one or more of the plurality of edges and (b) a yarn type of one or more of the plurality of edges.

The present technology has been described in relation to particular aspects, which are intended in all respects to be illustrative rather than restrictive. Alternative aspects will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the aspects depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Aspects described herein can be combined with one or more of the specifically described alternatives. In particular, an aspect that is claimed can contain a reference, in the alternative, to more than one other aspect. The aspect that is claimed can specify a further limitation of the subject matter claimed.

The subject matter of aspects of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, aspects of the present technology are described with reference to a distributed computing environment; however, the distributed computing environment depicted herein is merely exemplary. Components can be configured for performing novel aspects of aspects, where the term “configured for” can refer to “programmed to” perform particular tasks or implement particular abstract data types using code. Further, while aspects of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. A computerized method for creating an article, the method comprising:
receiving article design input data;
generating a first mesh data structure based on the article design input data,
wherein the first mesh data structure represents a plurality of knit structures in a first arrangement;
receiving a modification of at least one knit structure of the plurality of knit structures,
wherein the modification is received via a user interface design component that represents the plurality of knit structures in the first arrangement; and
automatically modifying the article design input data based on the modification of the at least one knit structure.

2. The computerized method of claim 1, wherein the article design input data is a first bitmap and the modified article design input data is a second bitmap.

3. The computerized method of claim 2, wherein each pixel within the first bitmap and each pixel within the second bitmap represents one needle position within a needle bed of a knitting machine.

4. The computerized method of claim 2, wherein the generating the first mesh data structure comprises:
converting the first bitmap to a second mesh data structure; and
mapping a plurality of units of the second mesh data structure to locations of the first mesh data structure.

5. The computerized method of claim 4, wherein the generating the first mesh data structure further comprises:
mapping anchor points within the second mesh data structure to corresponding anchor locations of the first mesh data structure; and
assigning spring lengths to edges of the second mesh data structure,
wherein the mapping the plurality of units of the second mesh data structure to the locations of the first mesh data structure is based on (a) the mapping the anchor points to the anchor locations and (b) the spring lengths.

6. The computerized method of claim 5, wherein the anchor locations correspond to a throat region of an upper component for an article of footwear.

7. The computerized method of claim 1, wherein the first arrangement of knit structures in the first mesh data structure has a shape corresponding to an upper component for an article of footwear.

8. The computerized method of claim 1 further comprising transmitting the modified article design input data to a knitting machine.

9. The computerized method of claim 8 further comprising generating computerized knitting instructions from the modified article design input data, wherein the computerized knitting instructions cause the knitting machine to knit the article.

10. The computerized method of claim 9, wherein the article is an upper component for an article of footwear.

11. The computerized method of claim 1,
wherein the article design input data comprises a plurality of pixels, and
wherein the first mesh data structure comprises a plurality of units, each unit within the plurality of units being mapped to a pixel within the plurality of pixels.

12. The computerized method of claim 11, wherein each unit of the plurality of units comprises four edges.

13. The computerized method of claim 1, wherein one or more edges of the first mesh data structure are assigned a spring length of zero to create wedging in the first mesh data structure.

14. The computerized method of claim 1, wherein the modification includes an assignment of a yarn color to the at least one knit structure.

15. The computerized method of claim 1, wherein the modification includes a change to at least one of (a) a shape of the at least one knit structure and (b) a location of the at least one knit structure.

16. The computerized method of claim 1,
wherein the creating the first mesh data structure comprises creating a mapping between (a) locations within the article design input data and (b) locations within the first mesh data structure, and
wherein the automatically modifying the article design input data is further based on the mapping.

17. The computerized method of claim 16 further comprising:
receiving a modification of the article design input data; and
automatically modifying the first mesh data structure based on (a) the mapping and (b) the modification of the article design input data.

18. A textile production system comprising:
one or more non-transitory computer readable media storing computer-executable instructions that, when executed, cause one or more computing devices to:
receive article design input data;
generate a first mesh data structure based on the article design input data,
wherein the first mesh data structure represents a plurality of textile structures in a first arrangement;
receive a modification of at least one textile structure within the plurality of textile structures,
wherein the modification is received via a user interface design component that represents the plurality of textile structures in the first arrangement, and
generate textile production instructions based on the modification of the at least one textile structure; and
a textile production machine configured to:
receive the textile production instructions; and
form an article based on the textile production instructions.

19. The textile production system of claim 18,
wherein the article design input data represents the plurality of textile structures in a second arrangement, and
wherein the first mesh data structure is generated at least partially based on the second arrangement.

20. The textile production system of claim 19, wherein the instructions further cause the one or more computing devices to:
convert the article design input data to a second mesh data structure,
assign spring lengths to edges of units of the second mesh data structure, and
generate the first mesh data structure based on the spring lengths.

21. The textile production system of claim 18, wherein the modification includes at least one of: an assignment of a yarn color to the at least one textile structure, an assignment of a knit stitch type to the at least one textile structure, a change to the yarn color of the at least one textile structure, and a change to the knit stitch type of the at least one textile structure.

22. One or more non-transitory computer-readable media storing computer-executable instructions for designing an article, wherein the instructions, when executed, cause one or more computing devices to:
receive a selection of an article design;
provide a user interface design component for display, wherein the user interface design component visually represents knit structures of the article design;
receive a user-selected modification of the article design, wherein the user-selected modification is at least one of an assignment of a yarn color, an assignment of a knit stitch type, a change to the yarn color, and a change to the knit stitch type; and
automatically generate computerized knitting instructions based on the article design and the user-selected modification, wherein the computerized knitting instructions are configured to control operation of a knitting machine such that the knitting machine knits the article.

23. The one or more non-transitory computer-readable media of claim 22, wherein the article comprises a knitted upper component for an article of footwear.

24. The one or more non-transitory computer-readable media of claim 22, wherein the knit structures of the article design are represented as a mesh data structure comprising a plurality of edges, and wherein the user-selected modification alters at least one of (a) a color of one or more of the plurality of edges and (b) a yarn type of one or more of the plurality of edges.
